(19) United States
(12) Patent Application Publication
(10) Pub. No.: US 2014/0302168 A1
(43) Pub. Date: Oct. 9, 2014

(54) Microbiocidal Solution with Ozone and Methods

(71) Applicant: Stephen C. Perry, Norwood, MA (US)

(72) Inventor: Stephen C. Perry, Norwood, MA (US)

(21) Appl. No.: 14/247,303

(22) Filed: Apr. 8, 2014

Related U.S. Application Data
(60) Provisional application No. 61/809,501, filed on Apr. 8, 2013.

(51) Int. Cl. A01N 59/00; C25B 1/26

(52) U.S. Cl. CPC A01N 59/00; C25B 1/26
USPC 424/613; 205/556

(57) ABSTRACT

A microbiocidal solution is provided that includes an electrolyzed saline solution, ozone, and active chlorine species producible via electrolysis that is usable to sanitize and disinfect a surface or substance. A method for producing a microbiocidal solution is provided that includes preparing a dilute saline solution and subjecting the dilute saline solution to electrolysis to produce an electrolyzed saline solution and active chlorine species and including ozone. A method also is provided for disinfecting a surface or substance using a microbiocidal solution where ozone disinfects via high oxidization properties and the active chlorine species provides a residual disinfectant effect. The microbiocidal solution may also include hydroxyl radicals and oxy-chloro species.

### CROSS-REFERENCE TO RELATED APPLICATION

This application is a nonprovisional application of U.S. provisional patent application Ser. No. 61/809,501 filed on Apr. 8, 2013. The foregoing application is incorporated in its entirety herein by reference.

### FIELD OF THE INVENTION

The present invention relates to a microbiocidal solution for sanitizing and disinfecting. The present invention also relates to a method for creating the microbiocidal solution.

### BACKGROUND

Historically, testing for microbial contamination has been used to test for contamination on surfaces. Testing may analyze ATP (adenosine triphosphate) by using a bioluminescence method, which can provide presumptive positive results in about 30 hours at levels of about 1-10 CFU/mL and negative results after about 48 hours. However, ATP bioluminescence lacks accuracy for detecting a number of bacteria on the surface over a range of concentrations. What is needed is a sanitizing solution with a high oxidation-reduction potential (ORP) that can sanitize a surface and be tested for effectiveness.

Sanitizers traditionally are used to disinfect and destroy pathogens. Aside from UV light sanitizers, oxidizers are often used in sanitization. Generally, stronger the oxidation results in a faster the rate at which a microbe is killed. The strength of oxidation reduction potential (ORP) may be measured by the activity of the sanitizer (in millivolts) rather than its concentration level (in ppm). Therefore, what is needed is a sanitizer that may be chosen by considering the needs of the user and their process requirements.

Traditionally, sanitizers having a level of 650 mV of ORP are used to kill bacteria such as E. coli in a few seconds of contact. Additionally, the World Health Organization has adopted an ORP standard of 650 mV for disinfection of drinking water. Sanitizers with higher levels of ORP (about 750 mV) are typically required to kill other organisms, such as yeasts and molds. However, no known solution exists in the prior art that balances the oxidation requirements with a desirous pH level and in an aqueous solution.

ORP can be measured in water using a voltmeter and one or more platinum electrodes. A voltage of the sanitizer is measured across a platinum tip in a potassium chloride or silver chloride reference cell. This voltage can be directly related to the efficacy of the sanitizing product in an aqueous medium. This voltage is analyzed against the background voltage of water, which is only a few hundred millivolts, to analyze an effectiveness of the sanitizer. Generally, ORP values below 650 mV are considered unsafe, as oxidation levels will suffer.

In a study performed by Dr. Jim Brown of the Oregon State Health Department, the ORP was determined to be a qualitative measure of choice for sanitizers to evaluate the safety of water and efficacy of the sanitizer. In Dr. Brown study, thirty public spas were examined for bacteria density and other variables, including ORP. PH levels were observed between 5.7 and 8.3, with a combined chlorine content of 1.4 to 34 ppm and free chlorine content from 0 to 30 ppm. Additionally, plate counts ranged between 0 and 15,000, and Pseudomonas were detected up to 12,400 CFU. However, a correlation was found between ORP and the presence of pathogens. Where ORP values were found above 630 mV, virtually no plate count existed. This correlation was found independent from the amount of free chlorine residuals detected.

Similarly, levels of bacterial activity are correlated with levels of bacterial activity in water. Studies have been performed to disinfect that show a direct link between ORP levels and coliform count in water. For example, ORP levels of 200 mV generally correlate with a coliform count of 300 in 100 mL of water. However, ORP levels of 600 mV generally correlate with a coliform count of 0 in 100 mL of water.

Almost all surfaces can become subject to the growth of undesired microbes. Likewise, such collection of microbes may develop in substances. Throughout history, chemicals have been developed to combat microbial infection and improve sanitary conditions. Chlorine is often used in disinfectants. Also, ozone has been used for cleaning laundered products. Additionally, certain combinations of ozone and chlorine increase disinfectant properties when used in combination, rather than when used separately, against a variety of bacteria including Staphylococcus aureus, Pseudomonas aeruginosa, and Candida albicans. For example, a combination of ozone and chlorine can be used for sanitizing water for bathing facilities.

In addition, electrolyzing dilute saline solutions may produce disinfecting agents with chlorine and hydroxide ions. Products resulting from electrolysis of saline solutions are generally known for their properties as in vitro microbiocides for hard surfaces. However, there exists no known product with ozone and useable hydroxyl radicals produced via such an apparatus for disinfectant purposes.

What is needed is a microbiocidal solution with a chlorine species producible via electrolysis and ozone to sanitize and disinfect a surface or substance. What is also needed are methods to produce the microbiocidal solution and to apply it to a surface. What is needed is a sanitizing solution with the chlorine species and ozone with oxidation properties of sufficient ORP to sanitize and disinfect a surface or substance. What is needed is a sanitizer chosen considering the needs of a user and their process requirements.

### SUMMARY

The present invention provides a microbiocidal solution with a chlorine species producible via electrolysis and ozone to sanitize and disinfect a surface or substance. The present invention also provides a method to produce the microbiocidal solution. The invention also provides a method for applying a microbiocidal solution to a surface. The present invention advantageously provides a sanitizing solution with the chlorine species and ozone with oxidation properties of sufficient ORP to sanitize and disinfect a surface or substance. The present invention advantageously provides a sanitizer chosen considering the needs of a user and their process requirements.

Accordingly, the invention features a microbiocidal solution that includes an electrolyzed saline solution, ozone, and active chlorine species. The chlorine species is producible via electrolysis. The microbiocidal solution is usable to sanitize and disinfect a surface or substance. The solution may inherit oxidation properties from the ozone and residual disinfectant effects from the chlorine species.

In another aspect, the active chlorine species can include chlorine concentration from at least one source selected from among free chlorine, hypochlorous acid, and hypochlorite ion. In another aspect, the active chlorine species can include chlorine concentration from at least two sources selected from among free chlorine, hypochlorous acid, and hypochlorite ion. In another aspect, the active chlorine species can include chlorine concentration from free chlorine, hypochlorous acid, and hypochlorite ion. The chlorine species may include, without limitation, hypochlorous acid, chloric(I) acid, chloranol, hydroxidochlorine, chlorine dioxide, dichlorine monoxide, oxygen dichloride, dichlorine oxide, chlorine(I) oxide, hypochlorous oxide, and/or hypochlorous anhydride.

In another aspect, the microbiocidal solution may further include hydroxyl radicals and/or oxy-chloro species from combining the chlorine species and the ozone.

In another aspect, the active chlorine species can include chlorine concentration attributable to moieties.

In another aspect, being usable to disinfect can include at least one disinfectant property selected from germicidal, pseudomonacidal, tuberculocidal, fungicidal, and/or virucidal.

In another aspect, the ozone may be concentrated at between about 2 and about 100 milligrams per liter (mg/L) and the active chlorine species may be concentrated at between about 2 and about 600 parts per million (ppm).

In another aspect, the electrolyzed saline solution may include about one percent (1%) or less saline solution.

In another aspect, a pH level of the microbiocidal solution may be between about 5 and about 7.6. In another aspect, a pH level of the microbiocidal solution may be between about 5.5 and about 6.5.

In another aspect, an ORP of the solution may be at least about 650 mV.

A method of the invention is provided for producing a microbiocidal solution that can include the steps of: (a) preparing a dilute saline solution; (b) subjecting the dilute saline solution to electrolysis to produce an electrolyzed saline solution and active chlorine species; and (c) including ozone. The microbiocidal solution is usable to sanitize and disinfect a surface or substance. The microbiocidal solution may inherit oxidation properties from the ozone and residual disinfectant effects from the chlorine species.

In another aspect of the method, the active chlorine species may be produced to include chlorine concentration from at least one source selected from among free chlorine, hypochlorous acid, and hypochlorite ion. In another aspect of the method, the active chlorine species may be produced to include chlorine concentration from at least two sources selected from among free chlorine, hypochlorous acid, and hypochlorite ion. In another aspect of the method, the active chlorine species may be produced to include chlorine concentration produced from free chlorine, hypochlorous acid, and hypochlorite ion. The chlorine species may include, without limitation, hypochlorous acid, chloric(I) acid, chloranol, hydroxidochlorine, chlorine dioxide, dichlorine monoxide, oxygen dichloride, dichlorine oxide, chlorine(I) oxide, hypochlorous oxide, and/or hypochlorous anhydride.

In another aspect, the microbiocidal solution may further include hydroxyl radicals and/or oxy-chloro species from combining the chlorine species and the ozone.

In another aspect of the method, the active chlorine species may be produced to include chlorine concentration attributable to moieties.

In another aspect of the method, being usable to disinfect can include at least one disinfectant property selected from among the properties of being germicidal, pseudomonacidal, tuberculocidal, fungicidal, and virucidal.

In another aspect of the method, step (b) may further include producing the ozone in concentration between about 2 and about 100 milligrams per liter (mg/L) and producing the active chlorine species in concentration between about 2 and about 600 parts per million.

In another aspect of the method, the electrolyzed saline solution can include about one percent (1%) or less saline solution.

In another aspect of the method, the method may further include the step of (c) producing the microbiocidal solution to have a pH level between about 5 and about 7.6.

In another aspect of the method, the method may further include the step of (d) producing the microbiocidal solution to have pH level between about 5.5 and about 6.5.

A method aspect is provided for using a microbiocidal solution to disinfect a surface or substance, which can include (a) applying the microbiocidal solution to a surface or substance that is microbally contaminated. The microbiocidal solution can include an electrolyzed saline solution, ozone, and active chlorine species. The method may also include (b) oxidizing a substantial amount of contaminants via the ozone. The method may further include (c) providing a residual disinfectant effect via the chlorine species. This method may include (d) disinfecting the surface using at least one disinfecting property of the microbiocidal solution selected from among the properties of being germicidal, pseudomonacidal, tuberculocidal, fungicidal, and virucidal. The chlorine species and/or the electrolyzed saline solution may be produced via electrolysis. The active chlorine species may be produced using chlorine concentration from at least one source selected from among free chlorine, hypochlorous acid, and hypochlorite ion. The microbiocidal solution may include hydroxyl radicals and oxy-chlorol species from combining the chlorine species and the ozone. The chlorine species may include, without limitation, hypochlorous acid, chloric(I) acid, chloranol, hydroxidochlorine, chlorine dioxide, dichlorine monoxide, oxygen dichloride, dichlorine oxide, chlorine(I) oxide, hypochlorous oxide, and/or hypochlorous anhydride.

In another aspect of the method, an ORP of the solution may be at least about 650 mV.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIGS. 1-6 are charts illustrating various examples of the composition, according to an embodiment of the present invention.

FIG. 7A is a chart illustrating an example of the composition, according to an embodiment of the present invention.

FIG. 7B is a graph plotting data illustrated in FIG. 7A.

FIG. 8A is a chart illustrating an example of the composition, according to an embodiment of the present invention.

FIG. 8B is a graph plotting data illustrated in FIG. 8A.

FIGS. 9-12 are charts illustrating various examples of the composition, according to an embodiment of the present invention.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

This disclosure uses the term “salt” to describe virtually any ionic crystalline structure that results from the neutralization of an acid and a base. Typically, the salt is comprised of an earth metal and a chloride, such as sodium chloride, magnesium chloride, potassium chloride, and/or other elements and compounds that would be apparent to a person of skill in the art. Designation of specific types of salts in particular embodiments of the invention, for example sodium chloride, is provided for illustrative purposes and is not intended to limit the present invention.

The invention provides a microbiocidal solution to disinfect and sanitize a surface or substance. More specifically, the microbiocidal solution may be used to clean, sanitize, deodorize, and disinfect, without limitation. The microbiocidal solution may have germicidal, pseudomonacidal, tuberculocidal, fungicidal, virucidal, biocidal, bacteriostatic, bactericidal, and other sanitizing disinfectant properties. The microbiocidal solution may be used to sanitize and disinfect surfaces, such as hard surfaces. Additionally, the microbiocidal solution may be used to sanitize and disinfect substances.

The electrolyzed solution may have oxidation reduction potential (ORP) sufficient to effectively reduce microbial contamination on the surface to which it is applied. For example, the electrolyzed solution of the present invention may include a level of ozone with an ORP of about 650 mV to 750 mV. However, those of skill in the art will appreciate inclusion of ozone to create a solution with differing levels of ORP, for example, without limitation, 150, 200, 250, 300, 350, 400, 450, 475, 500, 525, 550, 575, 600, 610, 615, 620, 625, 630, 635, 640, 650, 660, 670, 680, 690, 700, 710, 720, 730, 740, 750, 775, 800, 825, 850, 900, 950, 999, 1030 or another level measured in millivolts that would be appreciated by those of skill in the art.

The microbiocidal solution may include an electrolyzed saline solution having a content of regulated amounts of ozone and active chlorine species. The chlorine species may include, without limitation, hypochlorous acid, chloric(I) acid, chloranol, hydroxidochlorine, chlorine dioxide, dichlorine monoxide, oxygen dichloride, dichlorine oxide, chlorine(I) oxide, hypochlorous oxide, and/or hypochlorous anhydride. The electrolyzed saline solution may be produced via electrolysis of a dilute saline solution, which may include about one percent (1%) or less saline solution. Additional embodiments may include percentages of saline solution of about 0.5, 0.7, 0.8, 0.9, 1, 1.1, 1.2, 1.5, 2, 2.5, 3, 4, 5, 6, 8, 10, 12, 15, or 20 percent. Those of skill in the art will appreciate methods by which electrolysis of a dilute saline solution may produce an electrolyzed saline solution. Ozone may also be produced via the methods disclosed in U.S. Pat. Nos. 5,939,030 and 6,153,151, which are herein incorporated by reference in their entirety.

Active chlorine species is defined herein to include the total chlorine concentration attributable to chlorine content detectable by a chlorine ion selective electrode, and may be include chlorine from sources that include, but are not limited to, free chlorine, hypochlorous acid, and/or hypochlorite ion, which may add to the chlorine composition of the active chlorine species. The active chlorine species may also include chlorine composition attributable to moieties.

A person of skill in the art will appreciate techniques to generate ozone. For example, ozone may be generated in open or closed loop process applications using a fluid such as water as a primary process medium. Water may be processed using an electromagnetic flux unit, thereby magnetically polarizing contaminants and dissolved solids present in the water an apparatus for producing highly pure oxygen from ambient air. The pure oxygen may be used as a feed gas in generating ozone. A corona discharge ozone generator may produce high purity ozone from the highly pure oxygen feed gas using an impeller apparatus with rapidly rotating shear impeller to permeate ozone created by the ozone generator into water. The ozone may be absorbed by the water, thus yielding a substantially high level of dissolved ozone gas the water.

In another example, ozone may be created using a combined ozone and ozonites generator and ozone eliminator. The device in this example may have different modes of operation to control generation or elimination of ozone, with some modes being used for generating ozonites, some of which are generally less reactive and provide more far reaching beneficial effects than ozone alone. The device in the example may include one or more radiation sources, one of which may use approximately 185 nm radiation to disassociate atomic oxygen leading to creation of ozone, and another of which may use approximately 254 nm radiation to disassociate ozone, reducing its concentration, with both processes leading to creation of ozonites. These effects may be achieved by operating either radiation source separately or by operating both radiation sources simultaneously while drawing air through a chamber containing the radiation sources.

In an embodiment, the ozone content of the microbiocidal solution can be between about 2 and about 100 milligrams/liter (mg/L). In another embodiment, the ozone content of the microbiocidal solution can be between about 5 and about 30 mg/L. In yet another embodiment, the ozone content of the microbiocidal solution can be between about 9 and about 15 mg/L. Additional embodiments may include ozone in a range with a lower bound of about 0.5, 1, 1.5, 2, 2.5, 3, 4, 5, 6, 7, 8, 9, 10, 12, or 15 mg/L and an upper bound of about 10, 12, 15, 20, 25, 30, 35, 40, 50, 60, 70, 80, 90, 100, 110, 125, 150, 175, or 200 mg/L.

In an embodiment, the active chlorine species content of the microbiocidal solution is between about 5 and about 600 parts per million (ppm). In another embodiment, the active chlorine species content of the microbiocidal solution can be between about 10 and about 300 ppm. In yet another embodiment, the active chlorine species content of the microbiocidal solution can be between about 10 and about 100 ppm. Additional embodiments may include active chlorine species in a range with a lower bound of about 1, 2, 3, 4, 5, 6, 7, 8, 9, 10, 12, 15, 20, 30, 40, 50, 60, or 75 ppm and an upper bound of about 50, 60, 70, 80, 90, 100, 110, 125, 150, 175, 200, 250, 300, 350, 400, 450, 500, 550, 600, 650, 700, 750, 800, 900, or 1000 ppm.

In an embodiment, the pH of the microbiocidal solution can be between about 5 and about 7.6. In another embodiment, the pH of the microbiocidal solution can be between about 5.5 and about 6.5. Additional embodiments may include pH levels of the microbiocidal solution being about 4, 4.5, 4.8, 4.9, 5, 5.1, 5.2, 5.3, 5.5, 5.8, 5.9, 6, 6.1, 6.2, 6.5, 6.6, 6.7, 6.8, 6.9, 7, 7.1, 7.2, 7.3, 7.4, 7.5, 7.6, 7.7, 7.8, 7.9, or 8.

As discussed above the microbiocidal solution may be useful due to its disinfecting, antimicrobial, and/or decontamination properties. Examples of uses for the microbiocidal solution may include, but are not limited to, hospitals, nursing homes, whirlpools, hotels, motels, institutional settings, industrial settings, schools, dairy farms, equine farms/ranches, poultry and/or turkey farms, produce and vegetation farms, veterinary, restaurant, food handling and processing areas, federally inspected meat and poultry plants, bar and institutional kitchens. Additionally, the microbiocidal solution may be used for sanitizing ice machines, small fly ovicidal treatment, athletic surface disinfectant, non-acid bathroom cleaner, laundry sanitizer, laundry bacteriostat, fabric and mildew inhibitor and/or sanitizer, control of algae and algal slime growth in industrial and/or commercial recirculating cooling water towers and once-through fresh water cooling systems, and water treatment microbiocide for industrial and/or commercial recirculating cooling water systems, retort water systems, and oil field water flood/saltwater disposal system, and fracturing fluids. The microbiocidal solution can also be used as a food wash to disinfect and decontaminate the surfaces of consumable food items such as, for example, fruit and vegetables. Use of the microbiocidal solution to disinfect and decontaminate other substrates and surfaces in addition to those described herein is contemplated since the solution can be used on and applied to virtually any surface or substrate, and particularly to any hard and non-absorbent surface or substrate.

In the interest of clarity, an illustrative process of electrolysis to generate chlorine from a saline solution will now be discussed Skilled artisans will appreciate that the following process is not intended to limit the scope of the present invention in any way. Salt generators may produce chlorine from a mixture of sodium chloride (NaCl) and water (H2O). Sodium chloride may also be referred to through this disclosure as NaCl, without limitation. A direct electrical current may be passed through a solution of NaCl and water to separate the components. This process is known as electrolysis. The following equation shows the initial steps in this process:

2NaCl (s)+2H2O (l)→2NaOH (aq)+H2 (g)+Cl2 (g) EQUATION 1

The by-products produced include sodium hydroxide (NaOH), hydrogen gas (H2) and chlorine gas (Cl2). Sodium hydroxide is a very strong base with a high pH close to 14. The hydrogen gas is typically vented off into the air.

Chlorine gas (Cl2) may react with water (H2O) according to the following reaction:

Cl2 (g)+H2O (l)→HOCl (aq)+HCl (aq) EQUATION 2

Hypochlorous acid (HOCl) and hydrochloric acid or muriatic acid (HCl) may be produced. The HOCl is the sanitizing form of chlorine. Hydrochloric acid is a very strong acid with a very low pH while the hypochlorous acid is a weaker acid with a near neutral pH.

Two types of commercial salt generators will now be discussed, brine system generators and in-line generators. Brine system generators use a brine solution held in a two chamber-holding tank. A porous diaphragm or a membrane separates the two chambers. A positive electrode or the anode, is found on one chamber and the negative electrode or the cathode, is on the other chamber. Electricity and sodium ions (Na⁺) from the split sodium chloride molecule (NaCl) pass through the membrane. The chloride ions dissolved in the water (Cl aq) from the split NaCl molecule cannot pass through the membrane. This prevents the chemicals produced at each electrode from coming into contact with each other. In the chamber connected to the positive electrode or the anode, the chloride ion loses electrons to produce chlorine gas. The following equation illustrates this process:

Reaction at the Anode: 2Cl— (aq)→Cl2 (g)+2 electrons

The chlorine gas (Cl2) bubbles to the top of the chamber and may be drawn off and introduced into the water. The chlorine gas then reacts with water according to preceding equation (EQUATION 2) to produce hypochlorous acid (HOCl) and hydrochloric acid or muriatic acid (HCl).

In the chamber connected to the negative electrode or the cathode, the water molecule gains two electrons to produce hydrogen gas and the hydroxyl ion (OH⁻). The following equation illustrates this process:

Reaction at the Cathode: 2H2O (l)+2 electrons→H2 (g)+2OH— (aq) EQUATION 4

The sodium ions (Na+) combine with the hydroxyl ion (OH−) to produce sodium hydroxide (NaOH). Sodium hydroxide is a strong base with a very high pH. Brine systems are being less used today due to the problems with the disposal of very caustic sodium hydroxide that is produced.

In-line salt generators may produce chlorine using process water with a low concentration (2000-3000 ppm) of NaCl. Any form of earth-alkaline salt may be used. This means that the NaCl is typically added directly to the process water. Electrolysis of NaCl occurs in an electrolytic cell installed “in-line” in a recirculation system. The electrolytic cell may contain layers of plates in pairs that are electrically charged. Each plate is typically made of titanium plated with platinum, iridium, and/or ruthenium. The plates may have two identical sides that act as an anode/cathode pair. At each plate, the reactions shown above may occur at the anode and the cathode.

The common occurrence with this type of a generator is the formation of scale or calcium carbonate (CaCO3) and organic build-up on the plates. This build-up or fouling on the plates can inhibit the electrolysis process. When build-up or fouling occurs, the plates may need to be washed with a dilute solution of hydrochloric acid or muriatic acid, or the charge on the plates may need to be reversed to repel any build up that the opposite charge has attracted. In the presence of organic material, the scale may still build-up on the plates even when the charge on the plates has been reversed.

Traditional use of an inline salt generator may include disadvantages such as the fouling of the plates discussed above and the expense of replacing the titanium alloy plates. Another disadvantage of using an inline salt generator system may include problems that occur with water chemistry. As seen from equations (1) and (2), the salt generator produces NaOH, a strong base, HOCl, a weak acid, and HCl, a strong acid. The NaOH has a very high pH close to about 14. HOCl has a near neutral pH of about 5-7, and HCl has a very low pH of about 1. Based on the reaction balance or stoichiometry, two parts of NaOH are produced for every one part of HOCl and one part of HCl that are produced.

As the salt generator runs, the pH of the water may keep increasing and becoming more basic. The climbing pH has a definite effect on the efficiency of chlorine. The sanitizing form of chlorine, HOCl, is most efficient around pH 6.0-7.6. As the pH climbs above 7.6, the hypochlorite ion (OCl—) becomes more prominent in the water. The hypochlorite ion is less efficient at sanitizing than the hypochlorous acid. To correct this climbing pH, acid is typically added to the process water. If the acid is added incorrectly, it can burn-out the alkalinity which may lead to pH bounce and more problems in maintaining the process water chemistry.

The creation of ozone using an ozone generator and the chlorine species using electrolysis may be combined. For example, a water sanitizing apparatus may be used having a housing divided into separate narrow compartments through which a flow of water is directed sequentially in upward and downward directions. An ultraviolet ozone generator and pair of electrolysis plates may be mounted in one of the narrow compartments, with a salt in the flow of water being electrolyzed to form a sanitizing halogen in the presence of ultraviolet light from the ozone generator. In one embodiment, a bubble separator may be used to separate undissolved gases from the flow of water and re-apply such gases back to the flow of water upstream from the bubble separator.

Combination of the ozone and the chlorine species advantageously disinfects and sanitizes a surface and/or substance with high efficacy. The ozone may exploit its high oxidation properties, which damage fatty acids in the cell membranes of biological, organic, or other contaminants. In additional to the disinfecting properties of oxidation from the ozone, the inclusion of a chlorine species provides a residual disinfecting effectiveness, which may reduce the likelihood of the surface or substance being contaminated shortly after application of the microbiocidal solution.

In addition, the ozone and chlorine species may combine to produce hydroxyl radicals and oxy-chloro species. In one embodiment, this chlorine species may include hypochlorous acid. Hydroxyl radicals are known to damage virtually all types of macromolecules, which may include carbohydrates, nucleic acids, lipids, and amino acids. Additionally, oxy-chloro species are generally strong oxidizing agents, and may also be used to sanitize a surface or substance.

In the interest of clarity, a novel approach to producing a sanitizing solution with ozone, according to an embodiment of the present invention, will now be discussed without limitation. In this approach, ozone may be added into the process water to enhance the production of the sanitizing HOCl in the process water. Tremendous benefits may be achieved when ozone is used in conjunction with the HOCL chlorine species. Ozone and chlorine work well together, each advantageously fulfilling a unique and complementary role in a sanitizing and sanitation.

A water based sanitizing solution may involve at least three parts; biocidal action or disinfection, oxidation and a safety residual. Biocidal action or disinfection is the killing of viruses, bacteria, and algae, enteric bacteria, amoebic cysts, spores, and other contaminants on contact. Oxidation is the breakdown or altering of non-living wastes such as organics (greases and oils), which may be found in food wastes, industrial wastes and the like, as well as nitrogen containing compounds or amines found in human and animal wastes. Residual is the amount of free available biocide in the water to ensure that disinfection is fulfilled. The typically recommended free available chlorine (FAC) residual is 1.0-3.0 ppm. However, skilled artisans will appreciate additional embodiments with FAC residual of 0.5, 0.6, 0.7, 0.8, 0.9, 1, 2, 3, 4, 5, 6, 7, 8, 9, or 10 ppm.

When a chlorine species is used on its own, without other supplemental sanitizing products, approximately 15% of the FAC may be consumed for the biocidal action or disinfection, about 70% of the FAC may be consumed for partial oxidation, about 5% of the FAC may be consumed to produce a residual, and about 10% of the FAC may be sacrificed to exposure to UV light, for example, from the sun. Skilled artisans will appreciate that other combinations of FAC may be used that are consistent with the scope and spirit of the present invention. The above provided combination ratios are included in the interest of clarity and are not intended to limit the present invention in any way. For example, about 5, 10, 15, 20, 25, or 30% of the FAC may be consumed for biocidal action or disinfection. In another example, 50, 55, 60, 65, 70, 75, 80, 85, 90, or 95% of the FAC may be consumed for partial oxidation. In another example, 0, 1, 2, 3, 4, 5, 6, 7, 8, 9, 10, 11, 12, 13, 14, or 15% of the FAC may be consumed to produce the residual. In another example, 0, 1, 2, 3, 4, 5, 6, 7, 8, 9, 10, 11, 12, 13, 14, 15, 16, 17, 18, 19, or 20% of the FAC may be sacrificed to exposure to UV light.

Certain chlorine species are excellent disinfectants, but far weaker oxidizing agents than ozone. Oxidation is the removal of electrons from the bonds holding the molecules together. This removal of electrons breaks down or chemically alters the compound. Both ozone and chlorine are electron deficient and have a high oxidizing potential. This means that they oxidize other compounds by removing or sharing electrons. The strength of an oxidizing agent may be determined by the agent's electro negativity or the ability to pull electrons away from other compounds.

Ozone and chlorine differ in the speed and strength with which they oxidize other compounds. At aqueous residual levels (up to about 5.0 ppm), chlorine may share electrons with and becomes incorporated into the compound, thus chemically altering it. In this fashion, chlorine may combine with organic and amine compounds in the aqueous solution.

These compounds may include components of food wastes, organic wastes, dead algae, dead bacteria, and the like. Large amounts of chlorine species may be consumed in forming these new “chlorinated” compounds. Chlorine may therefore no longer be available to function as a biocide and residual. The altered chlorinated organic compounds (combines) may form scums, greases, and layers with calcium carbonate (CaCO3) that result in the formation of soft scale.

At the required residual levels, chlorine may also combine with nitrogen containing compounds or amines from organic wastes. The sanitizing form of aqueous chlorine, HOCl, reacts with these amines and related nitrogen compounds to form chloramines. The following reaction shows how chlorine combines with ammonia to form chloramines:

Formation of Chloramines: 3 HOCl+NH3→NCl3+3 H2O EQUATION 5

Chloramines are generally less effective biocides than HOCl and the hypochlorite ion (OCl—) by a factor of 10 or more. In addition, chloramines are responsible for the “chlorine” odor and eye and skin irritations associated with any chlorinated water. The formation of chloramines consumes considerable amounts of the free available chlorine (FAC). Consequently, more chlorine species may be needed to establish sufficient free chlorine residual in the sanitizing solution water.

Since ozone is a more powerful oxidizing reagent than chlorine, ozone may react with organic and nitrogen containing compounds faster than the chlorine species may react. Ozone does not combine with these compounds; instead it causes the organics to break apart. The smaller molecules broken apart by the ozone are more water soluble, and some can even gas off.

Amines and other nitrogen compounds may be altered so that they no longer combine with chlorine. Ozone may stop build-up of chlorinated organic and chloramine compounds and does not form combines.

To summarize, chlorine's biocidal and residual properties are excellent, and in the process water, chlorine may be the primary biocide and the free available residual. Ozone may be the primary oxidizer. Through this role, ozone increases chlorine's effectiveness as a biocide and residual, while allowing use of less chlorine. Ozone may provide a continual effective high-level non-chlorine sanitizing solution

In the interest of clarity, a relationship between ozone and salt generators will now be discussed without limitation. Since ozone may perform most of the oxidation work in the process water as a continual non-chlorine “shock,” ozone may increase the capacity of a salt generator system. Near the plates of the salt generator, where chlorine is generated, the concentration of chlorine may be high, for example, 20-40 ppm. This concentration may be high enough to ‘break-point Chlorinate’, ‘shock out,’ or oxidize waste. Without ozone, up to 80% of the sanitizing HOCl may be immediately consumed and would never be available as a sanitizing solution.

When an ozone generator is combined with a chlorine species generator, water that has already been oxidized by ozone may be sent to the salt generator plates. Typically, the ozone has ‘oxidized-out’ the organic and nitrogen compounds before they can reach the salt generator. At this point, approximately 80% of the HOCl may enter the process water to perform its disinfection function and can create a safety residual. In practice, this allows the chlorine generator to have about 2-3 times the capacity to disinfect and produce a residual.

From an equipment point of view, the ozone advantageously allows the salt generator to be operated less often. Additionally, salt generator plate-life may be increased and fouling of the plates is decreased due to the introduction of ozone, beneficially allowing expensive titanium alloy plates to last longer, for example, approximately twice as long.

A method is provided for producing the microbiocidal solution discussed above. The method may first include preparing a dilute saline solution. The method may next include subjecting the dilute saline solution to electrolysis with adequate voltage, amperage, and time to produce an electrolyzed solution that includes ozone and active chlorine species in designated concentrations. The electrical hydrolysis may also produce other products, including hydrogen, sodium, and hydroxide ions. The interaction of the products of the electrolysis may result in a solution containing bioactive atoms, radicals, and/or additional ions. The additional ions may include chlorine, ozone, hydroxide, hypochlorous acid, hypochlorite, peroxide, oxygen, other ions corresponding with resulting amounts of hydrogen, sodium, and hydrogen ions.

A method is also provided for using a microbiocidal solution, such as the composition described herein, disinfect a surface or substance. The method can include a first step of applying the microbiocidal solution to a surface or substance that is microbally contaminated. The microbiocidal solution can include an electrolyzed saline solution, ozone, and active chlorine species. This method may include an additional step of disinfecting the surface using at least one disinfecting property of the microbiocidal solution selected from a group that includes the properties of being germicidal, pseudomonacidal, tuberculocidal, fungicidal, virucidal, biocidal, bacteriostatic, and bactericidal.

### Example 1

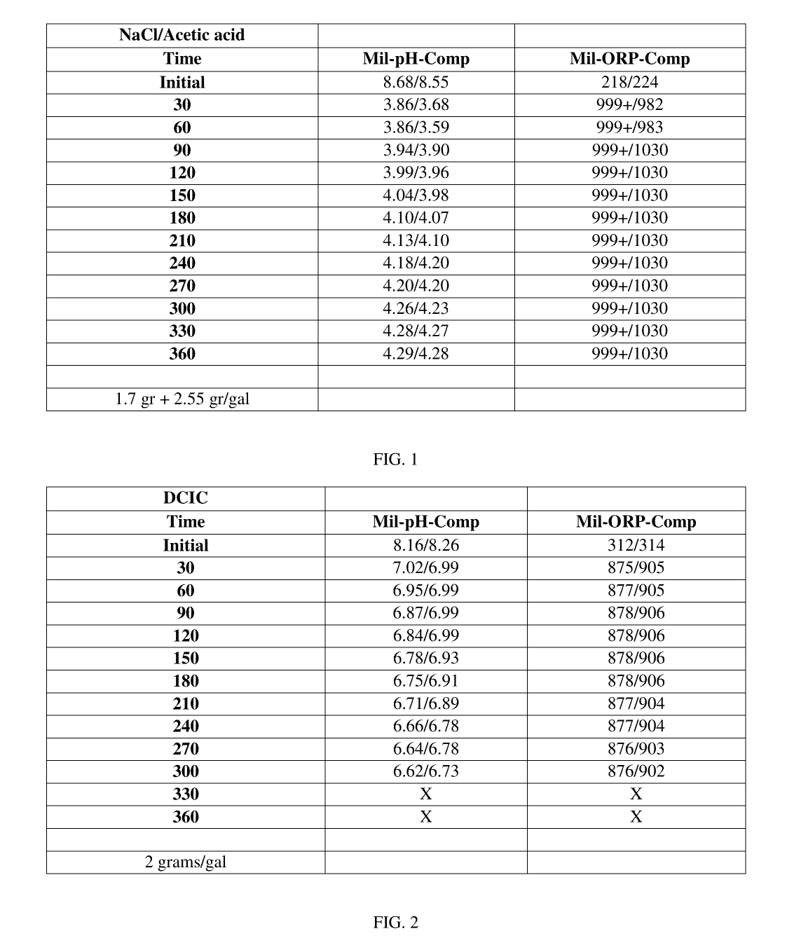

An example of the sanitizing solution will now be discussed along with results from trials, as illustrated in FIG. 1, without limitation. In this example, a composition including NaCl and ethanoic acid is tested having pH and ORP readings taken at different periods. For the purpose of this example, readings have been taken approximately every 30 seconds starting with an initial reading and ending approximately 360 seconds later. As can be seen by the results listed in FIG. 1, this example composition initially had readings for a pH level of 8.68/8.55 and ORP of 218/224. After about 30 seconds, the readings for the pH level were 3.86/3.68 and the readings for ORP were over 999/982. As the test progressed, the readings for pH continued to gradually rise, ending at about 4.29/4.28, and the readings for ORP about stabilized at over 999/1030.

### Example 2

Another example of the sanitizing solution will now be discussed along with results from trials, as illustrated in FIG. 2, without limitation. In this example, a composition including DCIC is tested having pH and ORP readings taken at different periods. For the purpose of this example, readings have been taken approximately every 30 seconds starting with an initial reading and ending approximately 300 seconds later. As can be seen by the results listed in FIG. 2, this example composition initially had readings for a pH level of 8.16/8.26 and ORP of 312/314. After about 30 seconds, the readings for the pH level were 7.02/6.99 and ORP were 875/905. As the test progressed, the readings for pH continued to gradually decrease, ending at about 6.62/6.73, and the readings for ORP approximately stabilized at around 878/906.

### Example 3

An example of the sanitizing solution will now be discussed along with results from trials, as illustrated in FIG. 3, without limitation. In this example, a composition including Chloramine T and NaCl is tested having pH and ORP readings taken at different periods. For the purpose of this example, readings have been taken approximately every 30 seconds starting with an initial reading and ending approximately 90 seconds later. As can be seen by the results listed in FIG. 3, this example composition initially had readings for a pH level of 7.49/7.44 and ORP of 650/649. After about 30 seconds, the readings for the pH level were 8.16/8.26 and ORP were 716/724. As the test progressed, the readings for pH continued to gradually increase, ending at about 8.38/8.51, and the readings for ORP gradually increased to 744/751.

### Example 4

Another example of the sanitizing solution will now be discussed along with results from trials, as illustrated in FIG. 4, without limitation. In this example, a composition including DCIC and NaCl is tested having pH and ORP readings taken at different periods. For the purpose of this example, readings have been taken approximately every 30 seconds starting with an initial reading and ending approximately 300 seconds later. As can be seen by the results listed in FIG. 4, this example composition initially had readings for a pH level of 8.48/8.41 and ORP of 596/638. After about 30 seconds, the readings for the pH level were 7.55/7.54 and ORP were 827/850. As the test progressed, the readings for pH continued to gradually increase, leveling off at about 7.99/8.02, and the readings for ORP gradually rose to around 831/852.

### Example 5

An example of the sanitizing solution will now be discussed along with results from trials, as illustrated in FIG. 5, without limitation. In this example, a composition including malic acid and NaCl is tested having pH and ORP readings taken at different periods. For the purpose of this example, readings have been taken approximately every 30 seconds starting with an initial reading and ending approximately 360 seconds later. As can be seen by the results listed in FIG. 5, this example composition initially had readings for a pH level of 8.94/8.85 and ORP of 314/312. After about 30 seconds, the readings for the pH level were 4.04/3.90 and ORP were over 999/1019. As the test progressed, the readings for pH continued to increase, ending at about 7.68/7.71, and the readings for ORP gradually decreased to about 801/815.

### Example 6

Another example of the sanitizing solution will now be discussed along with results from trials, as illustrated in FIG. 6, without limitation. In this example, a composition including NaCl, ethanoic acid, and BKC is tested having pH and ORP readings taken at different periods. For the purpose of this example, readings have been taken approximately every 30 seconds starting with an initial reading and ending approximately 30 seconds later. As can be seen by the results listed in FIG. 6, this example composition initially had readings for a pH level of 9.00/9.03 and ORP of 237/254. After about 30 seconds, the readings for the pH level were 3.81/3.76 and ORP were over 999/1030.

### Example 7

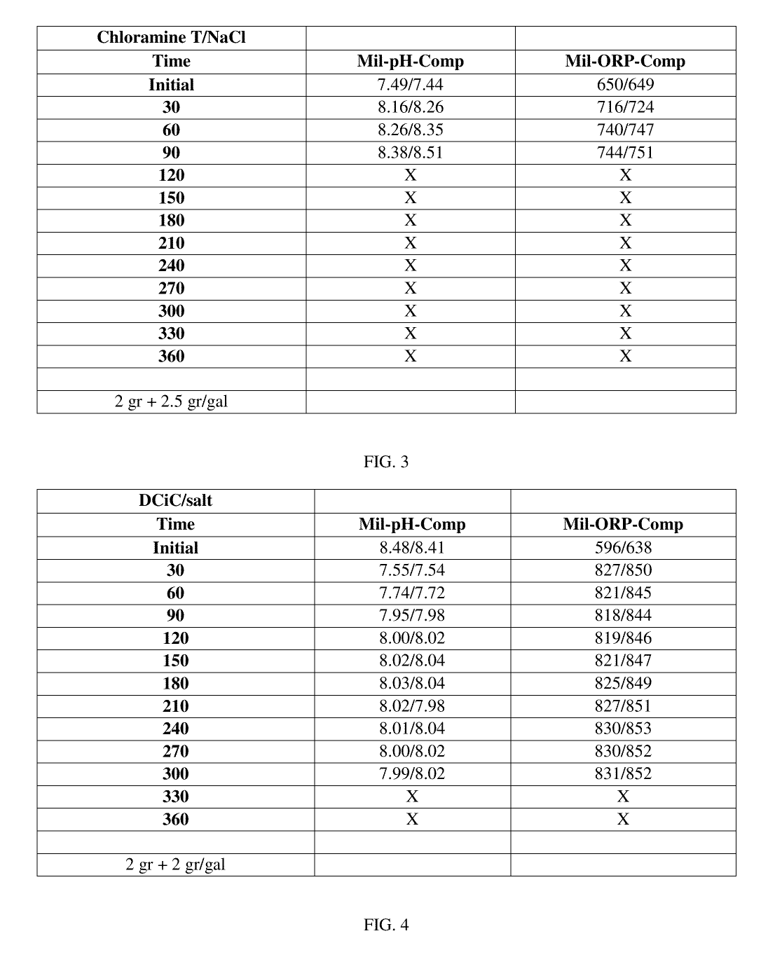

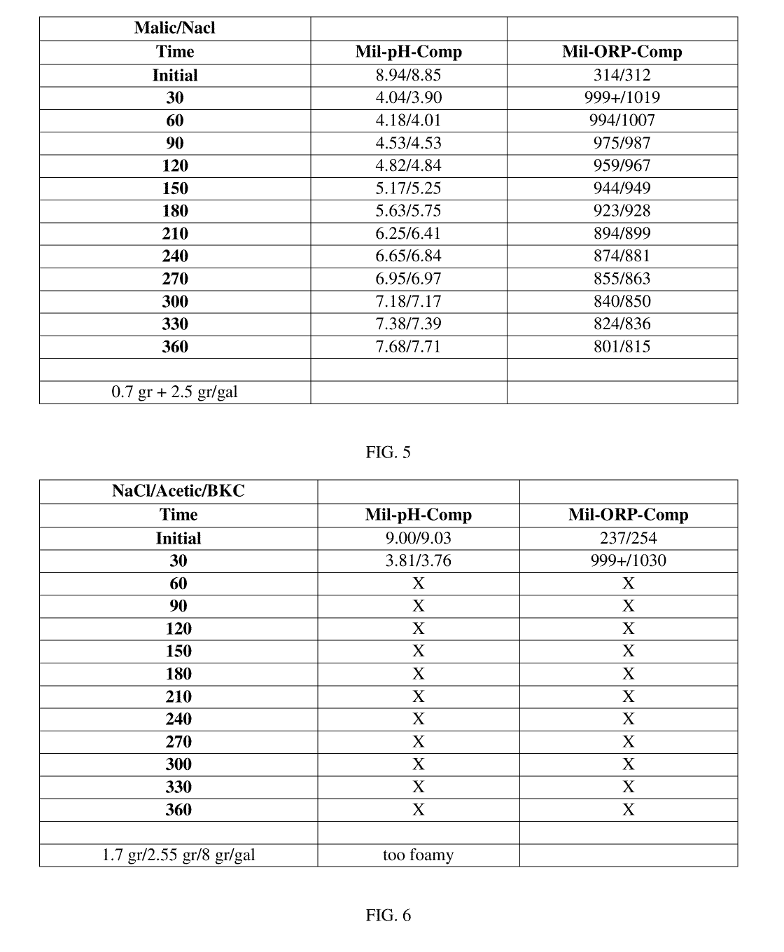

An example of the sanitizing solution will now be discussed along with results from trials, as illustrated in FIGS. 7A-7B, without limitation. In this example, a first composition including MgCl and ethanoic acid is compared with a second composition including NaCl and ethanoic acid. The first and second compositions are tested and compared by having pH and ORP readings taken at different periods. For the purpose of this example, readings have been taken approximately every 5, 10, 15, or 30 seconds starting with an initial reading and ending approximately 360 seconds later. As can be seen by the results listed in FIG. 7A, the first composition initially had readings for a pH level of 8.04 and ORP of 218 and the second composition initially had readings for a pH level of 8.63 and ORP of 276. After about 5 seconds, the readings of the first composition for the pH level were 3.91 and ORP were about 888 and the readings of the second composition for the pH level were 4.01 and ORP were about 865. As the test progressed for the first composition, the readings for pH continued to gradually increase, ending at about 5.08, and the readings for ORP stabilized at over 999. As the test progressed for the second composition, the readings for pH continued to gradually increase, ending at about 5.17, and the readings for ORP stabilized at over 999. The readings of this example are illustrated over time in FIG. 7B.

### Example 8

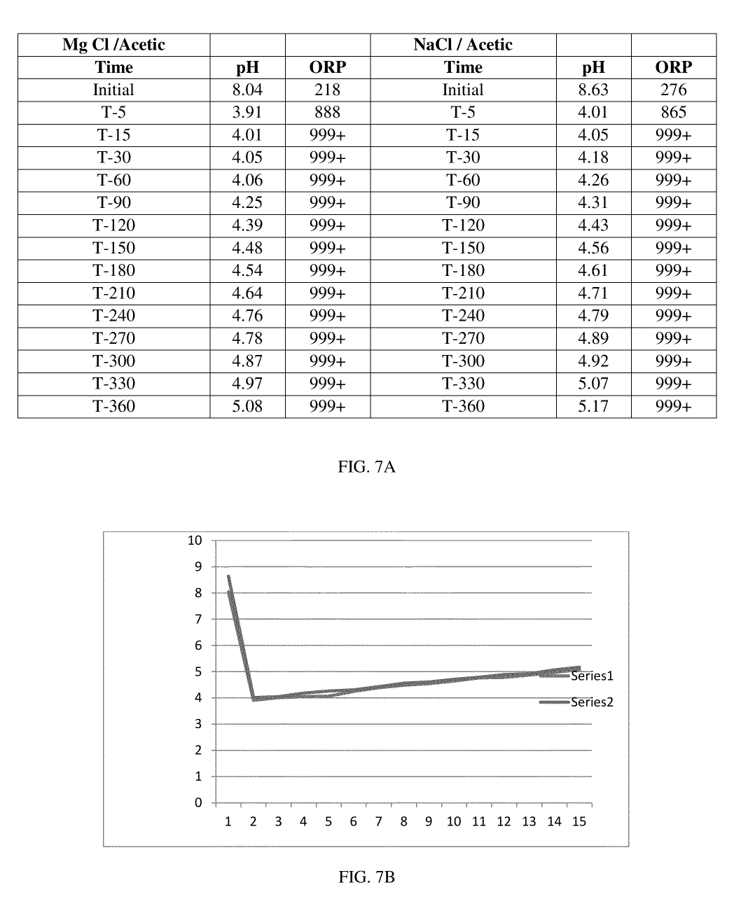

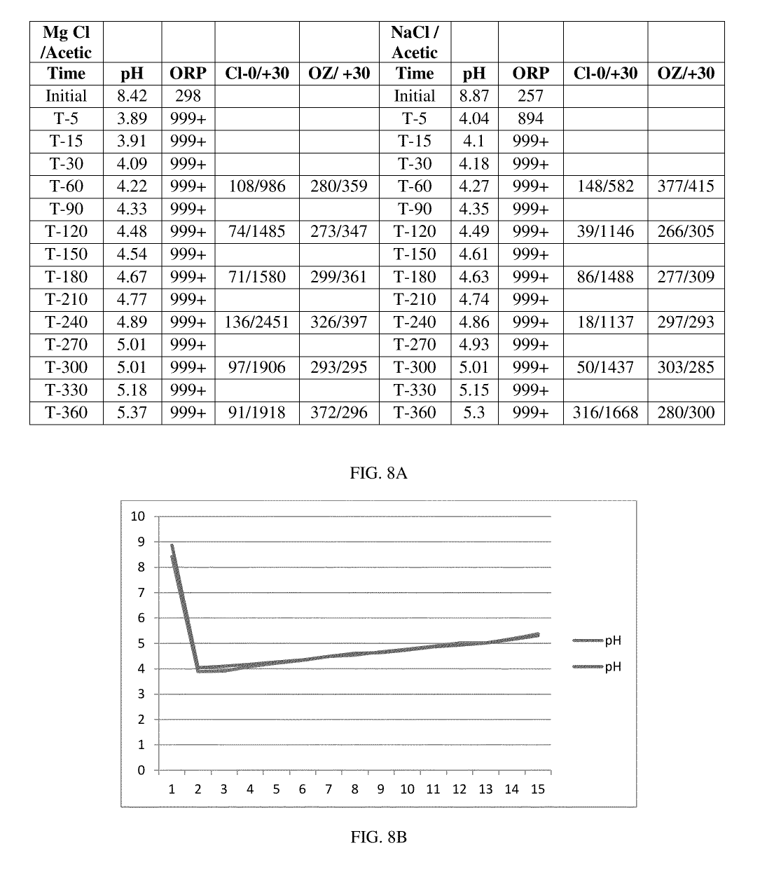

An example of the sanitizing solution will now be discussed along with results from trials, as illustrated in FIGS. 8A-8B, without limitation. In this example, a first composition including MgCl and ethanoic acid is compared with a second composition including NaCl and ethanoic acid. The first and second compositions are tested and compared by having pH and ORP readings taken at different periods. For the purpose of this example, readings have been taken approximately every 5, 10, 15, or 30 seconds starting with an initial reading and ending approximately 360 seconds later. Cl-0/+30 and OZ/+30 readings were taken at approximately 60 second intervals for the first and second compositions.

As can be seen by the results listed in FIG. 8A, the first composition initially had readings for a pH level of 8.42 and ORP of 298 and the second composition initially had readings for a pH level of 8.87 and ORP of 257. After about 5 seconds, the readings of the first composition for the pH level were 3.89 and ORP were over 999 and the readings of the second composition for the pH level were 4.04 and ORP were over 999. After about 60 seconds, the readings of the first composition for the pH level were 4.22 and ORP were over 999, with Cl-0/+30 reading of 108/986 and OZ/+30 reading of 280/359. Additionally, after about 60 seconds, the readings of the second composition for the pH level were 4.27 and ORP were over 999, with Cl-0/+30 reading of 148/582 and OZ/+30 reading of 377/415. As the test progressed for the first composition, the readings for pH continue to gradually increase, ending at about 5.37, the readings for ORP stabilized at over 999, and the values for CL-0/+30 and OZ/+30 fluctuated as illustrated in FIG. 8A. As the test progressed for the second composition, the readings for pH continued to gradually increase, ending at about 5.30, the readings for ORP stabilized at over 999, and the values for CL-0/+30 and OZ/+30 fluctuated as illustrated in FIG. 8A. The readings of this example are illustrated over time in FIG. 8B.

### Example 9

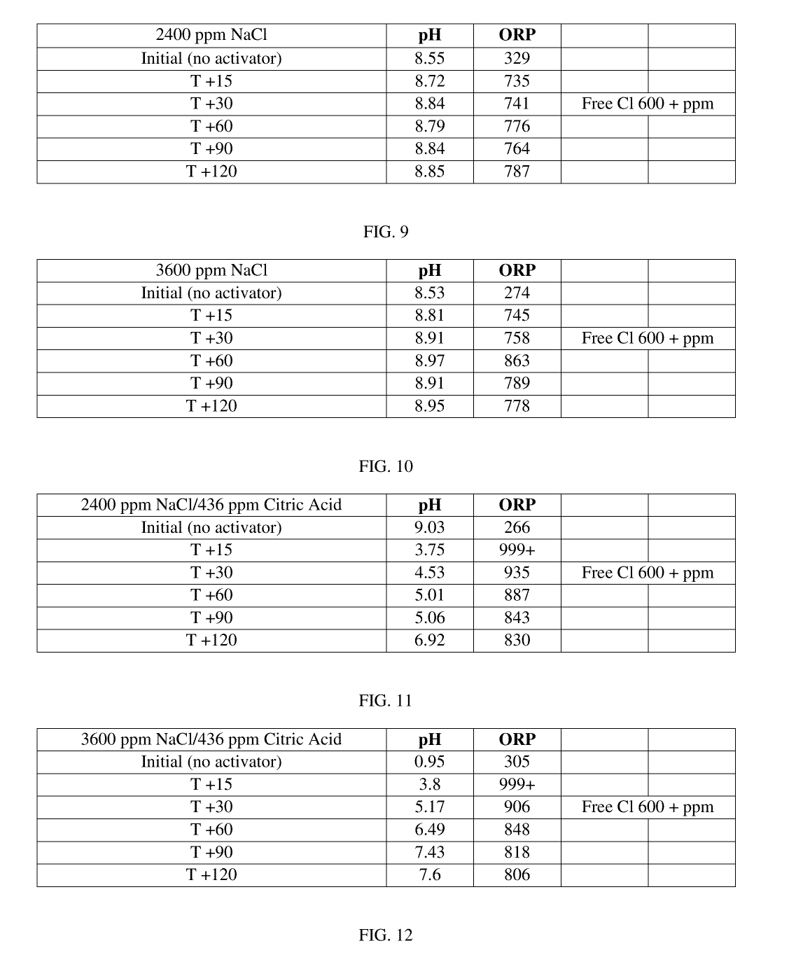

An example of the sanitizing solution will now be discussed along with results from trials, as illustrated in FIG. 9, without limitation. In this example, a composition including 2400 ppm NaCl is tested having pH and ORP readings taken at different periods. For the purpose of this example, readings have been taken approximately every 15 or 30 seconds starting with an initial reading and ending approximately 120 seconds later. As can be seen by the results listed in FIG. 9, this example composition initially had readings for a pH level of 8.55 and readings for ORP of 329. After about 15 seconds, the readings for the pH level were 8.72 and the readings for ORP were 735. As the test progressed, the readings for pH continued to gradually rise, ending at about 8.85, and the readings for ORP continued to gradually rise, ending at about 787.

### Example 10

An example of the sanitizing solution will now be discussed along with results from trials, as illustrated in FIG. 10, without limitation. In this example, a composition including 3600 ppm NaCl is tested having pH and ORP readings taken at different periods. For the purpose of this example, readings have been taken approximately every 15 or 30 seconds starting with an initial reading and ending approximately 120 seconds later. As can be seen by the results listed in FIG. 10, this example composition initially had readings for a pH level of 8.53 and readings for ORP of 274. After about 15 seconds, the readings for the pH level were 8.81 and the readings for ORP were 745. As the test progressed, the readings for pH about stabilize at about 8.95, and the readings for ORP fluctuate between about 758 and 863.

### Example 11

An example of the sanitizing solution will now be discussed along with results from trials, as illustrated in FIG. 11, without limitation. In this example, a composition including 2400 ppm NaCl and 436 ppm citric acid is tested having pH and ORP readings taken at different periods. For the purpose of this example, readings have been taken approximately every 15 or 30 seconds starting with an initial reading and ending approximately 120 seconds later. As can be seen by the results listed in FIG. 11, this example composition initially had readings for a pH level of 9.03 and readings for ORP of 266. After about 15 seconds, the readings for the pH level were 3.75 and the readings for ORP were over 999. As the test progressed, the readings for pH continued to rise, ending at about 6.92, and the readings for ORP gradually decreased, ending at about 830.

### Example 12

An example of the sanitizing solution will now be discussed along with results from trials, as illustrated in FIG. 12, without limitation. In this example, a composition including 2600 ppm NaCl and 436 ppm citric acid is tested having pH and ORP readings taken at different periods. For the purpose of this example, readings have been taken approximately every 15 or 30 seconds starting with an initial reading and ending approximately 120 seconds later. As can be seen by the results listed in FIG. 12, this example composition initially had readings for a pH level of 0.95 and readings for ORP of 305. After about 15 seconds, the readings for the pH level were 3.8 and the readings for ORP were over 999. As the test progressed, the readings for pH continued to gradually rise to about 7.6 and the readings for ORP gradually decrease to about 806.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A microbiocidal solution comprising:
an electrolyzed saline solution;
ozone; and
active chlorine species producible via electrolysis;
wherein the microbiocidal solution is usable to sanitize and disinfect a surface or substance;
wherein the microbiocidal solution inherits oxidation properties from the ozone and residual disinfectant effects from the active chlorine species.

2. The microbiocidal solution of claim 1, wherein the active chlorine species comprises chlorine concentration from at least one source selected from the group consisting of free chlorine, hypochlorous acid, and hypochlorite ion.

3. The microbiocidal solution of claim 1, wherein the active chlorine species comprises chlorine concentration from at least two sources selected from the group consisting of free chlorine, hypochlorous acid, and hypochlorite ion.

4. The microbiocidal solution of claim 1, wherein the active chlorine species comprises chlorine concentration produced from free chlorine, hypochlorous acid, and hypochlorite ion.

5. The microbiocidal solution of claim 1, wherein the active chlorine species comprises chlorine concentration attributable to moieties.

6. The microbiocidal solution of claim 1, further comprising hydroxyl radicals and oxy-chloro species from combining the active chlorine species and the ozone.

7. The microbiocidal solution of claim 1, wherein being usable to disinfect comprises at least one disinfectant property selected from the group consisting of germicidal, pseudomonacidal, tuberculocidal, fungicidal, and virucidal.

8. The microbiocidal solution of claim 1, wherein the ozone is concentrated at between about 2 and about 100 milligrams per liter (mg/L) and the active chlorine species is concentrated at between about 2 and about 600 parts per million (ppm).

9. The microbiocidal solution of claim 1, wherein the electrolyzed saline solution includes about one percent (1%) or less saline solution.

10. The microbiocidal solution of claim 1, wherein a pH level of the microbiocidal solution is between about 5 and about 7.6.

11. The microbiocidal solution of claim 1, wherein a pH level of the microbiocidal solution is between about 5.5 and about 6.5.

12. The microbiocidal solution of claim 1, wherein an oxidation reduction potential (ORP) of the solution is at least about 650 mV.

13. A method for producing a microbiocidal solution comprising the steps of:
(a) preparing a dilute saline solution;
(b) subjecting the dilute saline solution to electrolysis to produce an electrolyzed saline solution and active chlorine species; and
(c) including ozone;
wherein the microbiocidal solution is usable to sanitize and disinfect a surface or substance;
wherein the microbiocidal solution inherits oxidation properties from the ozone and residual disinfectant effects from the active chlorine species.

14. The method of claim 13, wherein the active chlorine species is produced comprising chlorine concentration from at least one source selected from the group consisting of free chlorine, hypochlorous acid, and hypochlorite ion.

15. The method of claim 13, wherein the active chlorine species is produced comprising chlorine concentration from at least two sources selected from the group consisting of free chlorine, hypochlorous acid, and hypochlorite ion.

16. The method of claim 13, wherein the microbiocidal solution further comprises hydroxyl radicals and oxy-chloro species from combining the active chlorine species and the ozone.

17. The method of claim 13, wherein the active chlorine species comprises chlorine concentration produced from free chlorine, hypochlorous acid, and hypochlorite ion.

18. The method of claim 13, wherein being usable to disinfect comprises at least one disinfecting property selected from the group consisting of: germicidal, pseudomonacidal, tuberculocidal, fungicidal, and virucidal.

19. The method of claim 13, wherein step (b) further comprises producing the ozone in concentration between about 2 and about 100 milligrams per liter (mg/L) and producing the active chlorine species in concentration between about 2 and about 600 parts per million.

20. The method of claim 13, wherein the electrolyzed saline solution comprises about one percent (1%) or less saline solution.

21. The method of claim 13, further comprising the step of:
(d) producing the microbiocidal solution to have a pH level between about 5 and about 7.6.

22. The method of claim 13, further comprising the step of:
(e) producing the microbiocidal solution to have pH level between about 5.5 and about 6.5.

23. A method for using a microbiocidal solution to disinfect a surface or substance comprising the steps of:
(a) applying the microbiocidal solution to a surface or substance that is microbally contaminated, wherein the microbiocidal solution comprises an electrolyzed saline solution, ozone, and active chlorine species;
(b) oxidizing a substantial amount of contaminants via the ozone;
(c) providing a residual disinfectant effect via the active chlorine species; and
(d) disinfecting the surface using at least one disinfecting property of the microbiocidal solution selected from a group consisting of: germicidal, pseudomonacidal, tuberculocidal, fungicidal, and virucidal;
wherein the active chlorine species and the electrolyzed saline solution are producible via electrolysis;
wherein the active chlorine species is produced comprising chlorine concentration from at least one source selected from the group consisting of: free chlorine, hypochlorous acid, and hypochlorite ion;
wherein the microbiocidal solution comprises hydroxyl radicals and oxy-chloro species form combining the active chlorine species and the ozone.

24. The method of claim 23, wherein an oxidation reduction potential (ORP) of the solution is at least about 650 mV.
